(19) United States
(12) Patent Application Publication
(10) Pub. No.: US 2006/0251858 A1
(43) Pub. Date: Nov. 9, 2006

(54) Elastic, breathable barrier films and laminates

(75) Inventors: Oomman Painumoottil Thomas, Alpharetta, GA (US); Janis Wilson Hughes, Alpharetta, GA (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 11/123,789

(22) Filed: May 6, 2005

(51) Int. Cl. B32B 3/10

(52) U.S. Cl. 428/138

(57) ABSTRACT

An elastic, breathable barrier sheet material and laminates thereof are disclosed that include a first layer including an apertured elastic film and a second layer including an extensible, breathable, non-elastic film, wherein the first layer is bonded to the second layer. Desirably, the second layer is unapertured. The elastic materials are useful, for example, in personal care products. Also disclosed is a process for making an elastic, breathable barrier laminate structure that includes the steps of: forming an elastic film; aperturing the elastic film; forming an extensible, breathable, non-elastic film; and bonding the apertured elastic film to the extensible, breathable, non-elastic film to form an elastic, breathable barrier film laminate.

### BACKGROUND

Sheet-like materials having high stretch and recovery properties and which also provide breathable barrier properties are desirable for use in many personal care products such as for example, diapers, training pants, and incontinence products. Industry has long recognized the benefits of combining the barrier properties of films with the cloth-like attributes of nonwoven fabrics, producing web/film laminates that may also exhibit certain levels of elasticity, stretchability, and breathability. A primary purpose of the film in such laminations is to provide barrier properties. There is also a need for such laminates to be breathable so that they have the ability to transmit moisture vapor. Apparel made from laminates of these breathable or microporous films are more comfortable to wear by reducing the moisture vapor concentration and the consequent skin hydration underneath the apparel item.

Breathable, elastic films are known in the art. For example, monolithic elastic films, such as those made from polyurethane elastomers are known to be inherently breathable. However, monolithic resins are relatively expensive, and films made from such resins can be difficult to make at the thin gauges and high speeds necessary to make such films cost effective. As another example, addition of fillers and subsequent stretching of elastic films creates breathability; however, the presence of the fillers can further result in considerable loss of elasticity and there are problems associated with maintaining breathability of filled elastic films since the recovery of the elastic material after stretching generally closes or partially closes the micropores which had been created for breathability. As a further example, cell openers or blowing agents can be used to create breathability in elastic films, however, the presence of the cell openers or blowing agents can lead to difficulty in making a thin film with uniform cell dimensions and openings. For example, some cells may be closed, while other cells may be excessively opened.

Therefore, there remains a need in the art for cost-effective elastic, breathable barrier films that are easy to make and cloth-like laminates made therefrom. Further, there exists a need for methods for producing such films and laminates which can be done in-line at high speeds. Finally, there is a need for personal care products and other garments which utilize such laminates in their composite constructions. It is to the provision of such articles and methods that the present invention is directed.

### SUMMARY OF THE INVENTION

In one embodiment, a breathable, elastic sheet material includes a first layer including an apertured elastic film and a second layer including an extensible, breathable, non-elastic film, wherein the first layer is bonded to the second layer. Desirably, the second layer is not apertured, and even more desirably serves as a barrier to the flow of liquid through the film. The breathable, elastic sheet material may further include an adhesive between the first and second layer. The adhesive may be a hot melt adhesive. Alternatively, the elastic sheet material may include an internal pressure sensitive adhesive for bonding the first and second layers

In one aspect, the apertured elastic film includes a styrenic block copolymer. In some embodiments, the styrenic block copolymer may be crosslinked. The apertured elastic film may further include a plastomer wax.

In another aspect, the apertured elastic film may include apertured zones and unapertured zones. In a further aspect, the apertured elastic film may include a plurality of slit openings. In an even further aspect, the surface of the extensible, breathable, nonelastic film exposed by the apertures in the elastic film may have a coefficient of friction different than the coefficient of friction of the exposed surface of the elastic film.

The extensible, breathable, non-elastic film may include 50 to 70 percent by volume filler particles.

In another embodiment, a breathable, elastic laminate structure includes a first sheet material that includes a first layer including an apertured elastic film and a second layer including an extensible, breathable, non-elastic film, wherein the first layer is bonded to the second layer. The breathable, elastic laminate structure further includes a second sheet material bonded to the first sheet material. The second sheet material may be, for example, a spunbonded facing material, a necked sheet material, and so forth. In one aspect, the breathable, elastic laminate structure may be a stretch bonded laminate. In another aspect, the breathable, elastic laminate structure may be a neck bonded laminate.

In a further embodiment, a personal care product includes a breathable, elastic laminate structure wherein the elastic laminate structure includes a first sheet material that includes a first layer including an apertured elastic film and a second layer comprising an extensible, breathable, non-elastic film wherein the first layer is bonded to the second layer. The breathable, elastic laminate structure further includes a second sheet material bonded to the first sheet material.

In an even further embodiment, a process for making a breathable, elastic laminate structure includes the steps of: forming an elastic film; aperturing the elastic film; forming an extensible, breathable, non-elastic film; and bonding the apertured elastic film to the extensible, breathable, non-elastic film to form a film laminate. In one aspect, the apertured elastic film is bonded to the extensible, breathable, non-elastic film with an adhesive that may be a hot melt adhesive. In another aspect, the elastic film may include a styrenic block copolymer and the process may further include the step of crosslinking the styrenic block polymer. In a further aspect, the apertured elastic film may be stretched prior to bonding the apertured elastic film to the extensible, breathable, nonelastic film and then bonded to the extensible, breathable, nonelastic film while the apertured elastic film is extended to form a stretch-bonded film laminate. In an even further aspect, the process may further include the step of bonding a facing sheet material to the film laminate. The facing sheet may be, for example, a spunbond material, a necked sheet material, and so forth. Optionally, the process may include the step of stretching the film laminate prior to the step of bonding a facing sheet material to the film laminate to form a stretch bonded laminate.

### BRIEF DESCRIPTION OF THE DRAWINGS

FIG. 1 is a cross-sectional schematic view of a material embodying the features of the present invention;

FIG. 2 is a schematic side elevation view illustrating an embodiment of a process in which the material of the present invention can be prepared;

FIG. 3 is a schematic drawing illustrating an embodiment of a process for combining the layers of the composite laminate construction of the present invention;

FIG. 4 is a schematic drawing illustrating a personal care product utilizing elastic breathable film laminates made in accordance with the invention; and

FIG. 5 is a graph depicting normalized load as a function of elongation for elastic breathable film laminates made in accordance with the invention.

Repeat use of reference characters in the present specification and drawings is intended to represent same or analogous features or elements of the present invention.

### DEFINITIONS

As used herein the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein, the term “spunbonded fibers” refers to small diameter fibers which are formed by extruding through one or more extruders attached to one or more banks made up of at least transfer piping and spinplates to produce molten thermoplastic material as filaments from a plurality of fine, usually circular, capillaries in a spinneret with the diameter of the extruded filaments then being rapidly reduced as by, for example, in U.S. Pat. No. 4,340,563 to Appel et al.; U.S. Pat. No. 3,802,817 to Matsuki, et al.; U.S. Pat. No. 3,692,618 to Dorschner et al.; U.S. Pat. Nos. 3,338,992 and 3,341,394 to Kinney; U.S. Pat. No. 3,502,763 to Hartman; and U.S. Pat. No. 3,542,615 to Dobo et al. Spunbond fibers are generally not tacky when they are deposited onto a collecting surface. Spunbond fibers are generally continuous and have average diameters (from a sample of at least 10) larger than 7 microns, more frequently, between about 10 and 40 microns. The resulting matt of fibers is then bonded to form a strong neckable fabric. This bonding may be performed by ultrasonic bonding, chemical bonding, adhesive bonding, thermal bonding, needle punching, hydroentangling and the like.

As used herein the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin et al. Meltblown fibers are microfibers which may be continuous or discontinuous, are generally smaller than 10 microns in average diameter, and are generally tacky when deposited onto a collecting surface.

As used herein the term “microfibers” means small diameter fibers having an average diameter not greater than about 75 microns, for example, having an average diameter of from about 0.5 microns to about 50 microns, more particularly, about 2 microns to about 40 microns. Another frequently used expression of fiber diameter is denier, which is defined as grams per 9000 meters of a fiber and may be calculated as fiber diameter (in microns) squared, multiplied by the polymer density in grams/cc, multiplied by 0.00707. For fibers made from the same polymer, a lower denier indicates a finer fiber and a higher denier indicates a thicker or heavier fiber. For example, the diameter of a polypropylene fiber given as 15 microns may be converted to denier by squaring, multiplying the result by 0.89 g/cc and multiplying by 0.00707. Thus, a 15 micron polypropylene fiber has a denier of about 1.42 (15²×0.89×0.00707=1.415). Outside the United States the unit of measurement is more commonly the “tex”, which is defined as the grams per kilometer of fiber. Tex may be calculated as denier/9.

Formation of a “bonded carded web” may be made using a number of known processes such as conventional carding equipment, for example. Desirable are those methods which result in a generally uniform blend of the fibers and produce a low density, bulky batt or web. Other examples include carding, picking and doffing apparatus as well as airlaying apparatus. In general, such equipment separates the fibers and redistributes them in an air stream with turbulent mixing and deposition on a collecting surface. Examples of such processes and apparatus can be found, for example in commonly assigned U.S. Pat. No. 4,548,856 to Ali Khan et al.

As used herein the term “laminate” or “multilayer laminate” means a combination made up of at least two sheet layers. For example, a laminate may include two film layers. As another example, a laminate may include at least one film layer and at least one layer of neckable material. As a further example, a laminate may include layers that are spunbond and meltblown such as a spunbond/meltblown/spunbond (SMS) laminate and others as disclosed in U.S. Pat. No. 4,041,203 to Brock et al., U.S. Pat. No. 5,169,706 to Collier, et al, U.S. Pat. No. 5,145,727 to Potts et al., U.S. Pat. No. 5,178,931 to Perkins et al. and U.S. Pat. No. 5,188,885 to Timmons et al. Such a laminate may be made by sequentially depositing onto a moving forming belt first a spunbond fabric layer, then a meltblown fabric layer and last another spunbond layer and then bonding the laminate in a manner described below. Such fabrics usually have a basis weight of from about 0.1 to 12 osy (3.4 to 400 gsm), or more particularly from about 0.75 to about 3 osy. Multilayer laminates may also have various numbers of meltblown layers or multiple spunbond layers in many different configurations and may include other materials like films (F) or coform materials, e.g. SMMS, SM, SFS, SFFS, FF, SFF, etc.

As used herein, the term “personal care product” means diapers, training pants, absorbent underpants, adult incontinence products, and feminine hygiene products.

As used herein the term “thermal point bonding” involves passing a fabric or web of fibers to be bonded between a heated calender roll and an anvil roll. The calender roll is usually, though not always, patterned in some way so that the entire fabric is not bonded across its entire surface, and the anvil roll is usually flat. As a result, various patterns for calender rolls have been developed for functional as well as aesthetic reasons. One example of a pattern has points and is the Hansen Pennings or “H&P” pattern with about a 30% bond area with about 200 bonds/square inch as taught in U.S. Pat. No. 3,855,046 to Hansen and Pennings. The H&P pattern has square point or pin bonding areas wherein each pin has a side dimension of 0.038 inches (0.965 mm), a spacing of 0.070 inches (1.778 mm) between pins, and a depth of bonding of 0.023 inches (0.584 mm). The resulting pattern has a bonded area of about 29.5%. Another typical point bonding pattern is the expanded Hansen Pennings or “EHP” bond pattern which produces a 15% bond area with a square pin having a side dimension of 0.037 inches (0.94 mm), a pin spacing of 0.097 inches (2.464 mm) and a depth of 0.039 inches (0.991 mm). Another typical point bonding pattern designated “714” has square pin bonding areas wherein each pin has a side dimension of 0.023 inches, a spacing of 0.062 inches (1.575 mm) between pins, and a depth of bonding of 0.033 inches (0.838 mm). The resulting pattern has a bonded area of about 15%. Yet another common pattern is the C-Star pattern which has a bond area of about 16.9%. The C-Star pattern has a cross-directional bar or “corduroy” design interrupted by shooting stars. Other common patterns include a diamond pattern with repeating and slightly offset diamonds with about a 16% bond area and a wire weave pattern looking as the name suggests, e.g. like a window screen, with about a 19% bond area. Typically, the percent bonding area varies from around 10% to around 30% of the area of the fabric laminate web. As is well known in the art, the spot bonding holds the laminate layers together as well as imparts integrity to each individual layer by bonding filaments and/or fibers within each layer.

As used herein, the term “ultrasonic bonding” means a process performed, for example, by passing the fabric between a sonic horn and anvil roll as illustrated in U.S. Pat. No. 4,374,888 to Bornslaeger.

As used herein, the term “elastic” means any material which, upon application of a biasing force, is stretchable, that is, elongatable or extensible, at least about 60 percent (i.e., to a stretched, biased length which is at least about 160 percent of its relaxed unbiased length), and which will immediately recover at least 55 percent of its elongation upon release of the stretching, elongating force. By “immediately” what is meant is that the elastic material will behave, for instance, as a rubber band to recover as soon as the elongating force is removed. A hypothetical example would be a one (1) inch sample of a material which is elongatable to at least 1.60 inches (4.06 cm) and which, upon being elongated to 1.60 inches (4.06 cm) and released, will immediately, i.e. within less than one second, recover to a length of not more than 1.27 inches (3.23 cm). Many elastic materials may be elongated by much more than 60 percent, for example, 100 percent or more, and many of these will recover to substantially their initial relaxed length, for example, to within 105 percent of their initial relaxed length upon release of the stretching force.

As used herein, the term “non-elastic” or “inelastic” means any material falling outside the definition of the term “elastic”.

As used herein the term “composite elastic material” refers to an elastic material which may be a multicomponent material or a multilayer material in which one layer is elastic. These materials may be, for example, “stretch bonded” laminates (SBL) and “neck bonded” laminates (NBL). Conventionally, “stretch bonded” refers to an elastic member being bonded to another member while the elastic member is extended at least about 25 percent more than of its relaxed length. “Stretch bonded laminate” refers to a composite material having at least two layers in which one layer is a gatherable layer and the other layer is an elastic layer. The layers are joined together when the elastic layer is in an extended condition so that upon relaxing the layers, the gatherable layer is gathered. Such a multilayer composite elastic material may be stretched to the extent that the nonelastic material gathered between the bond locations allows the elastic material to elongate. One type of stretch bonded laminate is disclosed, for example, by U.S. Pat. No. 4,720,415 to Vander Wielen et al., in which multiple layers of the same polymer produced from multiple banks of extruders are used. Other composite elastic materials are disclosed in U.S. Pat. No. 4,789,699 to Kieffer et al., U.S. Pat. No. 4,781,966 to Taylor and U.S. Pat. Nos. 4,657,802 and 4,652,487 to Morman and U.S. Pat. No. 4,655,760 to Morman et al.

Conventionally, “neck bonded” refers to an elastic member being bonded to a non-elastic member while the non-elastic member is extended under conditions reducing its width or necked. “Neck bonded laminate” refers to a composite material having at least two layers in which one layer is a necked, non-elastic layer and the other layer is an elastic layer. The layers are joined together when the non-elastic layer is in an extended condition. Examples of neck-bonded laminates are such as those described in U.S. Pat. Nos. 5,226,992, 4,981,747, 4,965,122 and 5,336,545 to Morman.

As used herein the term “nonwoven fabric or web” means a web having a structure of individual fibers or threads which are interlaid, but not in an identifiable manner as in a knitted fabric. Nonwoven fabrics or webs have been formed from many processes such as for example, meltblowing processes, spunbonding processes, and bonded carded web processes. The basis weight of nonwoven fabrics is usually expressed in ounces of material per square yard (osy) or grams per square meter (gsm) and the fiber diameters useful are usually expressed in microns. (Note that to convert from osy to gsm, multiply osy by 33.91).

As used herein, the term “machine direction” or MD or “longitudinal direction” or LD means the direction of a fabric in the direction in which it is produced. The term “cross machine direction” or CD or “transverse direction” or TD means the opposite direction of the fabric, i.e. a direction generally perpendicular to the MD.

As used herein, the term “neck” or “neck stretch” interchangeably means that a sheet material is drawn such that it is extended under conditions reducing its width or its transverse dimension by drawing and elongating to increase the length of the fabric. The controlled drawing may take place under cool temperatures, room temperature or greater temperatures and is limited to an increase in overall dimension in the direction being drawn up to the elongation required to break the sheet material, which in most cases is about 1.2 to 1.6 times. The sheet material can then be heated to impart a heat set to the necked sheet material. When relaxed, the sheet material does not retract toward its original longitudinal dimension or extend to its original transverse dimension, but instead essentially maintains its necked dimension. The necking process typically involves unwinding a sheet from a supply roll and passing it through a brake nip roll assembly driven at a given linear speed. A take-up roll or nip, operating at a linear speed higher than the brake nip roll, draws the fabric and generates the tension needed to elongate and neck the fabric. U.S. Pat. No. 4,965,122 issued to Morman, and commonly assigned to the assignee of the present invention, discloses a reversibly necked nonwoven material which may be formed by necking the material, then heating the necked material, followed by cooling and is incorporated herein by reference in its entirety. The heating of the necked material causes additional crystallization of the polymer giving it a heat set.

As used herein, the term “neckable material or layer” means any material which can be necked such as a nonwoven, woven, or knitted material. As used herein, the term “necked material” refers to any material which has been drawn in at least one dimension, (e.g. lengthwise), reducing the opposite dimension, (e.g. width), such that when the drawing force is removed, the material can be pulled back to its original width. The necked material has a higher basis weight per unit area than the un-necked material. When the necked material is pulled back to its original un-necked width, it should have about the same basis weight as the un-necked material. This differs from stretching/orienting the film layer, during which the film is thinned and the basis weight is reduced.

As used herein, the term “breathable”, and variations thereof, indicates a significant permeability to water vapor, as well as other gases such as CO₂ and O₂. The breathability is expressed as water vapor transmission rate (WVTR) measured in units of g/day/m² of water vapor passing through the material. A suitable technique for determining the WVTR value of a film is the test procedure standardized by INDA (Association of the Nonwoven Fabric Industry), number IST-70.4-99, which is incorporated by reference herein. A testing device which may be used for WVTR measurement is known as the Permatran-W Model 100K manufactured by Mocon Modern Controls, Inc., with an office in Minneapolis, Minn.

As used herein, “coefficient of friction” is a relative value determined from measurements of particular dynamic or kinetic coefficients of friction between material pairs. The coefficient of friction can be determined using a particular variation of ASTM method D1894-00.

### DETAILED DESCRIPTION OF THE INVENTION

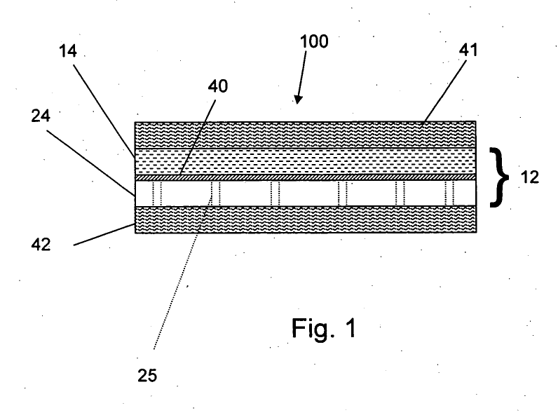

In one embodiment, the present invention is directed to an elastic, breathable barrier material comprising a first layer and a second layer. Referring to FIG. 1, an elastic, breathable barrier material 100 comprises a film laminate 12 including a first layer 14 and a second layer 24. The first layer 14 is a breathable extensible film layer. The breathable extensible film layer 14 desirably exhibits good liquid barrier properties. The second layer 24 is an elastic film layer. The elastic film layer 24 desirably includes apertures 25 extending through the thickness of the elastic film layer. Furthermore, the elastic film layer is desirably highly extensible. The film laminate 12 optionally includes a breathable adhesive layer 40. Optionally, the film laminate 12 may be laminated to first and second facing materials 41, 42.

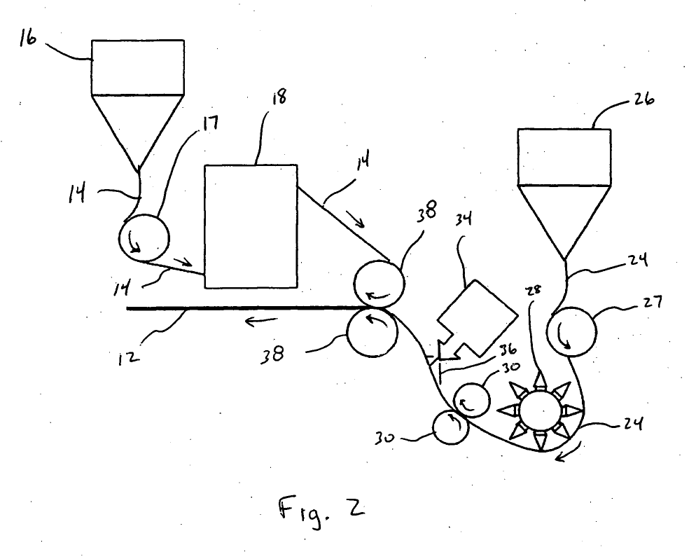

Referring to FIG. 2, there is schematically illustrated an exemplary process 10 for forming the elastic, breathable barrier material 100. A breathable extensible film layer 14 is cast from a first extruder 16 onto a first chill roll 17 from which the breathable extensible film layer 14 is optionally fed into a stretching means 18. Alternatively, the breathable extensible film layer 14 may be unwound from a supply roll (not shown). Desirably, the stretching means 18 may be a machine direction orienting unit (MDO). Once in the stretching means 18, the breathable extensible film layer 14 is partially stretched in a longitudinal direction by stretching rollers (not shown) which stretch and thin the breathable extensible film layer 14. Such stretching desirably occurs with little or no necking of the film layer. If the distance between the stretching rollers is too large, irreversible narrowing of the film layer can occur. After partially stretching the breathable extensible film layer 14 and prior to laminating to an elastic film layer 24, the tension of the breathable extensible film layer 14 is only that which is sufficient to keep the layer from sagging or retracting. In other words, it is not necessary to continue stretching the breathable extensible film layer 14 between the stretching means 18 and a laminating means 30.

An elastic film layer 24 likewise is cast from a second extruder 26 onto a second chill roll 27 from which the elastic film layer 24 is fed into an aperturing means 28. Alternatively, the elastic film layer 24 may be unwound from a supply roll (not shown) and fed into the aperturing means 28. In the aperturing means 28, the apertures 25 are formed in the elastic film layer 24. A set of nip rollers 30 tensions the elastic film layer 24 as it passes through the aperturing means 28. After the apertured elastic film layer 24 passes through the nip rollers 30, an adhesive sprayer 34 applies adhesive 36 to the surface (not shown) of the elastic film layer 24. The elastic film layer 24 is then laminated in face-to-face relation to the breathable extensible film layer 14 using the laminating means 38 to form the elastic, breathable barrier film laminate 12. In one embodiment, the laminating means 38 may be a set of nip rollers. The elastic, breathable barrier film laminate 12 could also be bonded by thermal point bonding, ultrasonic bonding, sonic welding, point bonding, radio frequency bonding, or the like. In one embodiment, the apertured elastic film 24 may be stretched prior to bonding the apertured elastic film to the extensible, breathable, nonelastic film 14 and then bonded to the extensible, breathable, nonelastic film while the apertured elastic film is extended. The elastic, breathable barrier film laminate 12 may then be allowed to retract to form a stretch-bonded film laminate.

The breathable extensible film layer 14 can be made from either cast or blown film equipment, can be coextruded and can be embossed if so desired. The film layer may be made from any suitable extensible polymer composition.

Such polymers include but are not limited to extrudable polymers such as polyolefin or a blend of polyolefins, nylon, polyesters, and ethylene vinyl alcohol. More particularly, useful polyolefins include polypropylene and polyethylene. Other useful polymers include those described in U.S. Pat. No. 4,777,073 to Sheth, assigned to Exxon Chemical Patents Inc., such as a copolymer of polypropylene and low density polyethylene or linear low density polyethylene.

Other useful polymers include those referred to as single site catalyzed polymers such as “metallocene” polymers produced according to a metallocene process and which have limited elastic properties. For example, the single site catalyzed polymers may be elastic polyolefin-based polymer. The term “metallocene-catalyzed polymers” as used herein includes those polymer materials that are produced by the polymerization of at least ethylene using metallocenes or constrained geometry catalysts, a class of organometallic complexes, as catalysts. For example, a common metallocene is ferrocene, a complex of a metal between two cyclopentadienyl ligands. Metallocene process catalysts include bis(n-butylcyclopentadienyl)titanium dichloride, bis(n-butylcyclopentadienyl)zirconium dichloride, bis(cyclopentadienyl)scandium chloride, bis(indenyl)zirconium dichloride, bis(methylcyclopentadienyl)titanium dichloride, bis(methylcyclopentadienyl)zirconium dichloride, cobaltocene, cyclopentadienyltitanium trichloride, ferrocene, hafnocene dichloride, isopropyl(cyclopentadienyl,-1-flourenyl)zirconium dichloride, molybdocene dichloride, nickelocene, niobocene dichloride, ruthenocene, titanocene dichloride, zirconocene chloride hydride, zirconocene dichloride, among others. A more exhaustive list of such compounds is included in U.S. Pat. No. 5,374,696 to Rosen et al. and assigned to the Dow Chemical Company. Such compounds are also discussed in U.S. Pat. No. 5,064,802 to Stevens et al. and also assigned to Dow.

Such metallocene polymers are available from Exxon Chemical Company of Baytown, Tex. under the trade name ACHIEVE® for polypropylene based polymers and EXACT® for polyethylene based polymers. Dow Chemical Company of Midland, Mich. has polymers commercially available under the name ENGAGE®. In one embodiment, the metallocene polymers are selected from copolymers of ethylene and 1-butene, copolymers of ethylene and 1-hexene, copolymers of ethylene and 1-octene and combinations thereof. For a more detailed description of the metallocene polymers and the process for producing same which are useful in the present invention, see commonly assigned PCT Patent Publication WO98/29246 to Gwaltney et al., which is incorporated herein by reference in its entirety. In general, the metallocene-derived ethylene-based polymers of the present invention have a density of at least 0.900 g/cc.

Another example of a suitable elastic polyolefin-based polymer is VISTAMAXX elastomer, available from ExxonMobil Chemical Company of Houston, Tex. Other examples of suitable polyolefin-based polymers include EXACT plastomer, OPTEMA ethylene methacrylate, and VISTANEX polyisobutylene, and metallocene-catalyzed polyethylene, all available from ExxonMobil Chemical Company, as well as AFFINITY polyolefin plastomers, such as AFFINITY EG 8185, AFFINITY GA 1900, AFFINITY GA 1950, and VERSIFY propylene-ethylene copolymers available from Dow Chemical Company of Midland, Mich.; ELVAX ethylene vinyl acetate, available from E. I. Du Pont de Nemours and Company of Wilmington, Del.; and ESCORENE ULTRA ethylene vinyl acetate, available from ExxonMobil Chemical Company.

The breathable extensible film layer 14 may be a multi-layered film layer which may include a core layer, or “B” layer, and one or more skin layers, or “A” layers, on either side or both sides of the core layer. When more than one skin layer is present, is not a requirement that the skin layers be the same. For instance, there may be an A layer and an A′ layer. Any of the polymers discussed above are suitable for use as a core layer of a multi-layered film. Any of the fillers disclosed herein are suitable for use in any film layer.

The skin layer will typically include extrudable thermoplastic polymers and/or additives which provide specialized properties to the non-elastic film layer. Thus, the skin layer may be made from polymers which provide such properties as antimicrobial, barrier, water vapor transmission, adhesion and/or antiblocking properties. The polymers are thus chosen for the particular attributes desired. Examples of possible polymers that may be used alone or in combination include homopolymers, copolymers and blends of polyolefins as well as ethylene vinyl acetate (EVA), ethylene ethyl acrylate (EEA), ethylene acrylic acid (EAA), ethylene methyl acrylate (EMA), ethylene butyl acrylate (EBA), polyester (PET), nylon (PA), ethylene vinyl alcohol (EVOH), polystyrene (PS), polyurethane (PU), and olefinic thermoplastic elastomers which are multistep reactor products wherein an amorphous ethylene propylene random copolymer is molecularly dispersed in a predominately semicrystalline high polypropylene monomer/low ethylene monomer continuous matrix. The skin layer can be formed of any semicrystalline or amorphous polymer, including one that is elastic. However, the skin layer is generally a polyolefin such as polyethylene, polypropylene, polybutylene or a ethylene-propylene copolymer, but may also be wholly or partly polyamide such as nylon, polyester such as polyethylene terephthalate, polyvinylidene fluoride, polyacrylate such as poly(methyl methacrylate)(only in blends) and the like, and blends thereof.

The breathable extensible film layer 14 of the present invention can be made from breathable materials or can be made breathable prior to lamination to the elastic film layer 24. The non-elastic film layer may contain such fillers as micropore developing fillers, e.g. calcium carbonate; opacifying agents, e.g. titanium dioxide; and antiblock additives, e.g. diatomaceous earth.

Fillers may be incorporated for developing micropores during orientation of the non-elastic film layer resulting in breathable films. The fillers may be blended in a carrier resin such as, for example, polyethylene. Once the particle-filled film has been formed, it is then either stretched or crushed to create pathways through the film layer. In one embodiment, the filled film may have a water vapor transmission rate (WVTR) of at least about 250 g/m²/24 hours as may be measured by a test method as described above. Desirably, the filled film will have a WVTR of at least about 800 g/m²/24 hours.

As used herein, a “micropore developing filler” is meant to include particulates and other forms of materials which can be added to the polymer and which will not chemically interfere with or adversely affect the extruded film but are able to be uniformly dispersed throughout the film layer. Generally, the micropore developing fillers will be in particulate form and usually will have somewhat of a spherical shape with average particle sizes in the range of about 0.5 to about 8 microns. The breathable, extensible film layer 14 will usually contain at least about 20 volume percent, desirably about 20 to about 70 volume percent, more desirably about 50 to about 70 volume percent, of micropore developing filler based upon the total volume of the film layer. Both organic and inorganic micropore developing fillers are contemplated to be within the scope of the present invention provided that they do not interfere with the film formation process, the breathability of the resultant non-elastic film layer, the liquid barrier properties of the film layer or its ability to bond to another sheet layer.

Examples of micropore developing fillers include calcium carbonate (CaCO₃), various kinds of clay, silica (SiO₂), alumina, barium sulfate, sodium carbonate, talc, magnesium sulfate, titanium dioxide, zeolites, aluminum sulfate, cellulose-type powders, diatomaceous earth, magnesium sulfate, magnesium carbonate, barium carbonate, kaolin, mica, carbon, calcium oxide, magnesium oxide, aluminum hydroxide, pulp powder, wood powder, cellulose derivative, polymer particles, chitin and chitin derivatives. The micropore developing filler particles may optionally be coated with a fatty acid, such as stearic acid, or a larger chain fatty acid such as behenic acid, which may facilitate the free flow of the particles (in bulk) and their ease of dispersion into the polymer matrix. Silica-containing fillers may also be present in an effective amount to provide antiblocking properties.

The elastic film layer 24 may be made from polymers which are capable of being formed into a film and then bonded to the breathable extensible film layer 14. The film may be newly formed or pre-formed film.

Such film forming polymers include but are not limited to extrudable elastomeric thermoplastic polymers. Such polymers include those made from block copolymers such as polyurethanes, copolyether esters, polyamide, polyether block copolymers, ethylene vinyl acetates (EVA), block copolymers having the general formula A-B-A′ or A-B like copoly(styrene/ethylene-butylene), styrene-poly(ethylene-propylene)-styrene, styrene-poly(ethylene-butylene)-styrene, (polystyrene/poly(ethylene-butylene)/polystyrene, poly(styrene/ethylene-butylene/styrene) and the like. Specifically, the elastomeric thermoplastic polymers include: polyester elastomeric materials such as, for example, those available under the trade designation KRATON from KRATON Polymers LLC of Houston, Tex., those available under the trade designation HYTREL® from E. I. du Pont de Nemours and Company; polyester block amide copolymers such as, for example, those available in various grades under the trade designation PEBAX® from Atofina Chemicals Inc., of Philadelphia, Penn.; and polyurethane elastomeric materials such as, for example, those available under the trademark ESTANE® from Noveon, Inc. of Cleveland, Ohio.

As mentioned above, the elastic film layer 24 may be formed from a thermoplastic elastic formulation including elastomeric block copolymers. For example, multi-block copolymers including, for instance, di-block copolymers having the general formula A-B, tri-block copolymers having the general formula A-B-A′, or tetrablock copolymers having the general formula A-B-A′-B′ or A-B-B′-A′, where A and A′ are the same or different, and B and B′ are the same or different may be used. A and A′ each being a thermoplastic polymer block which contains a styrenic moiety and B and B′ being an elastomeric polymer block such as a conjugated diene or a lower alkene polymer or their saturated equivalents. In general, the elastomeric block copolymers may contain up to about 35% styrene. For example, the block copolymers may contain from about 15% to about 30% styrene. In one embodiment, block copolymers such as those available from KRATON Polymers LLC of Houston, Tex. under the brand name KRATON® or those available from Dexco Polymers of Houston, Tex. under the trade name VECTOR™ may be used. In these block copolymers, the polystyrene is a thermoplastic with a glass transition temperature above room temperature (T_{g} about 75° C.) and the elastomeric block is a rubber with a glass transition temperature well below room temperature. As such, the polystyrene and the elastomeric block are thermodynamically incompatible. Because of this incompatibility, the polystyrene blocks, being in minor proportion in the elastomeric polymer, may unite to form polystyrene domains that may be uniformly distributed throughout the elastomeric material. This creates a stable matrix similar to that of vulcanized polybutadiene, natural rubber, or styrene-butadiene rubber.

As used herein the term “styrenic moiety” is defined as a monomeric unit represented by the formula:

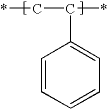

In one embodiment, the A and A′ blocks may be selected from the group including polystyrene and polystyrene homologs such as poly(alpha-methylstyrene).

In one embodiment, the B and B′ blocks may be polyisoprene, poly(ethylene-propylene), polyethylene, polybutadiene, or poly(ethylene-butylene).

In one embodiment of the elastic film layer 24, elastomeric block copolymers may be utilized having a saturated or essentially saturated poly(ethylene-propylene) elastomeric block B and/or B′ segments having the following general formula: 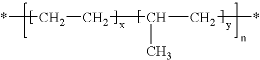
where x, y, and n are positive integers, and polystyrene A and/or A′ segments represented by the formula: 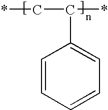
where n is a positive integer. Such elastomeric block copolymers are sometimes referred to as S-EP-S (polystyrene/poly(ethylene-propylene)/polystyrene) tri-block copolymers or S-EP-S-EP (polystyrene/poly(ethylene-propylene)/polystyrene/poly(ethylene-propylene))tetra-block copolymers. Specific embodiments of these block copolymers are available under the trademark KRATON® G, for example, KRATON® G-1701, KRATON® G-1702 and KRATON® G-1730 from KRATON Polymers of Houston, Tex. KRATON® G-1701 has a block styrene percent mass of 37%, a Shore A hardness of 64, and a solution viscosity of 50 Pa-s at 25% mass in toluene at 25° C. KRATON® G-1702 has a block styrene percent mass of 28%, a Shore A hardness of 41, and a solution viscosity of 50 Pa-s at 25% mass in toluene at 25° C. KRATON® G-1730 has a block styrene percent mass of 21% and a Shore A hardness of 66. In one embodiment, these exemplary ethylene-propylene block copolymers may also be combined with radial S-EP-S block copolymers, such as those designated G-1750M and G-1765 available from the KRATON Polymers Company.

In another embodiment, block copolymers including poly(ethylene-propylene) B segments and polyethylene B′ segments may be utilized represented by the formula: 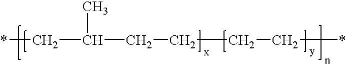
where x, y and n are positive integers, and polystyrene A and A′ blocks as defined above may be used. These block copolymers are sometimes referred to as S-E-EP-S (polystyrene/polyethylene/poly(ethylene-propylene)/polystyrene) block copolymers, and are available under the trademark SEPTON 4033, SEPTON 4044, SEPTON 4055, and SEPTON 4077 from the Septon Company of America of Pasadena, Tex. SEPTON 4033 has a styrene content of about 30 wt %, a Shore A hardness of about 76, and a 10 wt % solution viscosity of 50 mpa-s. SEPTON 4044 has a styrene content of about 32 wt %, and a 10 wt % solution viscosity of 460 mPa-s. SEPTON 4055 has a styrene content of about 30 wt %, and a 10 wt % solution viscosity of 5800 mPa-s. SEPTON 4077 has a styrene content of about 30 wt %, and a 5 wt % solution viscosity of 300 mPa-s.

In another embodiment, block copolymers including poly(ethylene-butylene) B and/or B′ segments may be utilized represented by the formula: 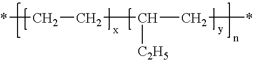
where x, y and n are positive integers, and polystyrene A and A′ blocks as defined above may be used. These block copolymers are sometimes referred to as S-EB-S (polystyrene/poly(ethylene-butylene)/polystyrene) tri-block copolymers, and are available under the trademark KRATON G, for example, KRATON G-1650, KRATON G-1652 and KRATON G-1657M from KRATON Polymers of Houston, Tex. KRATON G-1650 has a block styrene percent mass of 30%, a Shore A hardness of 72, and a solution viscosity of 8 Pa-s at 25% mass in toluene at 25° C. KRATON G-1652 has a block styrene percent mass of 30%, a Shore A hardness of 75, and a solution viscosity of 1.35 Pa-s at 25% mass in toluene at 25° C. KRATON G-1657M has a block styrene percent mass of 13% and a Shore A hardness of 47.

Other elastomeric resins which may be utilized in forming the elastic film layer 24 include block copolymers where A and A′ are polystyrene blocks, as defined above, and B and/or B′ is a polybutadiene block represented by the following formula:
* [symbol] CH₂—CH═CH—CH₂ [symbol] ₙ*
where n is a positive integer. This material is sometimes referred to as a S—B—S tri-block copolymer and is available from KRATON Polymers of Houston, Tex. under the trade designation KRATON D; for example, KRATON D-1101, KRATON D-1102 and KRATON D-1116. According to KRATON Polymers, KRATON D-1101 has a block styrene percent mass of 31%, a Shore A hardness of 69, and a solution viscosity of 4 Pa-s at 25% mass in toluene at 25° C. KRATON D-1102 has a block styrene percent mass of 28% and a Shore A hardness of 66. KRATON D-1116 has a block styrene percent mass of 23%, a Shore A hardness of 63, and a solution viscosity of 9 Pa-s at 25% mass in toluene at 25° C. These block copolymers are available as porous pellets and have a specific gravity of 0.94.

Another S—B—S block copolymer suitable for use in the elastic film layer 24 is commercially available under the trade designation SOLPRENE® and CALPRENE® from the Dynasol Company of Houston, Tex.

Other elastomeric resins which may be utilized to form the elastic film layer 24 are block copolymers where A and A′ are polystyrene blocks, as defined above, and B and/or B′ are polyisoprene blocks where the polyisoprene block may be represented by the formula: 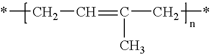
where n is a positive integer. These block copolymers are sometimes referred to as S—I—S tri-block copolymers and are also available from KRATON Polymers under the trade designation KRATON D, for example, KRATON D-1107, KRATON D-1111, KRATON D-1112P and KRATON D-1117. KRATON D-1107 has a block styrene percent mass of 15%, a Shore A hardness of 32, and a solution viscosity of 1.6 Pa-s at 25% mass in toluene at 25° C. KRATON D-1111 has a block styrene percent mass of 22%, a Shore A hardness of 45, and a solution viscosity of 1.2 Pa-s at 25% mass in toluene at 25° C. KRATON D-1112P has a block styrene percent mass of 15%, a Shore A hardness of 25, and a solution viscosity of 0.9 Pa-s at 25% mass in toluene at 25° C. KRATON D-1117 has a block styrene percent mass of 17%, a Shore A hardness of 32, and a solution viscosity of 0.7 Pa-s at 25% mass in toluene at 25° C. The D-1111 grade is available as a porous pellet having a specific gravity of 0.93. The D-1107, D-1112 and D-1117 block copolymers are available as pellets having specific gravities of 0.92.

In one embodiment, the KRATON D polymers described above may be cross linked after formation of the elastic film 24 to improve elastic performance of the film and/or the film laminate. Such cross linking may be performed either before or after the elastic film 24 is apertured, laminated to the breathable extensible film layer 14, or laminated to any other material.

These exemplary block copolymers are not believed to contain plasticizer oils although they are commercially available in compounded form.

It should be understood that the elastic film layer 24 is not limited to the foregoing list of exemplary elastomeric block copolymers and other suitable elastomeric block copolymers may alternatively be utilized in the disclosed elastic webs.

Additionally and/or alternatively, the elastic film layer 24 may include the single site catalyzed polymers such as “metallocene” polymers produced according to a metallocene process that are described above for the breathable extensible film layer 14.

The elastic film layer 24 may be a multi-layered film which may include a core layer, or “B” layer, and one or more skin layers, or “A” layers on either side of the core layer. Any of the polymers discussed above are suitable for use as a core layer of a multi-layered film.

The skin layer will typically include extrudable thermoplastic polymers and/or additives which provide specialized properties to the elastic film layer 24. Thus, the skin layer may be made from polymers which provide such properties as antimicrobial activity, water vapor transmission, adhesion and/or antiblocking properties. The polymers are thus chosen for the particular attributes desired. Examples of possible polymers that may be used alone or in combination include homopolymers, copolymers and blends of polyolefins as well as ethylene vinyl acetate (EVA), ethylene ethyl acrylate (EEA), ethylene acrylic acid (EAA), ethylene methyl acrylate (EMA), ethylene butyl acrylate (EBA), polyester (PET), nylon (PA), ethylene vinyl alcohol (EVOH), polystyrene (PS), polyurethane (PU), and olefinic thermoplastic elastomers which are multistep reactor products wherein an amorphous ethylene propylene random copolymer is molecularly dispersed in a predominately semicrystalline high polypropylene monomer/low ethylene monomer continuous matrix.

Suitable polymers for the “A” layer are available commercially under the trade designation “Catalloy” from Basell North America Inc. of Wilmington, Del., and polypropylene. Other suitable polymers include polymers which are semi-crystalline/amorphous or heterophasic in character. Such polymers are disclosed in European Patent Application EP 0444671 A3, European Patent Application EP 0472946 A2, European Patent Application EP 0400333 A2, U.S. Pat. No. 5,302,454 and U.S. Pat. No. 5,368,927. For a more detailed description of films having core and skin layers see U.S. Pat. No. 6,653,523 to McCormack et al. assigned to common assignee which is incorporated herein by reference in its entirety.

The elastic films can be made from breathable or non-breathable materials. Some films are made breathable by adding micropore developing filler particles to the film during the film forming process. However, micropore developing filler particles often degrade elastic performance and are desirably not present in the elastic film.

The elastic film may contain flow modifiers, plasticizers, pigments, antioxidants, slip agents, plastomer waxes, and other conventionally employed additives. Optionally, the elastic film may include the addition of a tackifier. Tackifiers are used to provide a tacky film surface that will autogenously bond and thus tackifiers improve bondability of the elastic film in a laminate construction. Known tackifiers include hydrocarbon resins, rosin and rosin derivatives, polyterpenes and other similar materials. One such known tackifier is WINGTACK 10, a synthetic polyterpene resin that is liquid at room temperature, and sold by the Goodyear Tire and Rubber Company of Akron, Ohio. WINGTACK 95 is a synthetic tackifier resin also available from Goodyear that comprises predominantly a polymer derived from piperylene and isoprene. Other known tackifying additives include ESCOREZ 1310, an aliphatic hydrocarbon resin, and ESCOREZ 2596, a C₅-C₉ (aromatic modified aliphatic) resin, both manufactured by ExxonMobil Chemical of Houston, Tex. Other tackifiers that may be used include hydrogenated hydrocarbon resins such as REGALREZ™ hydrocarbon resins available from Eastman Chemical Company of Kingsport, Tenn. Terpene hydrocarbons may also be used as tackifiers in elastomeric formulations including, for example, ZONATAK™ 501 lite.

Processes for forming film are generally known. The elastic film layer 24 can be made from either cast or blown film equipment, can be coextruded and can be embossed if so desired. Additionally, the elastic film layer 24 can be stretched or oriented by passing the film through a film stretching unit. The stretching may reduce the film gauge or thickness from an initial gauge of 1.5-2.0 mils to an effective final gauge of 0.5 mils or less. Generally, this stretching may take place in the CD or MD or both.

Processes and/or means for forming apertures in film are generally known. Suitable means for forming apertures include pin aperturing, slitting, slitting and stretching, vacuum aperturing, and so forth. For example, aperture openings may be formed in a film by nipping the film in a nip area defined between an anvil roll and a patterned roll. The patterned roll may have a plurality of depressed areas, such as on a gravure roll, a plurality of raised lands or pins, or other three-dimensional surface wherein only select areas of the surface contact the film material passing through the nip area defined between the anvil roll and the patterned roll. The anvil roll may be smooth, or may have a plurality of depressed areas corresponding to a plurality of raised areas on the pattern roll. Pressure is applied in the nip between the anvil roll and the patterned roll to create the apertures. The anvil roll or the patterned roll may be rotated at different speeds to facilitate creation of the apertures. Moreover, the anvil roll or the patterned roll may be heated or cooled to facilitate creation of the apertures in the film. Exemplary mechanical methods of aperturing film are described, for example, in U.S. Pat. No. 5,536,555 to Zelazoski et al., and U.S. Pat. No. 5,704,101 to Majors, et al., each of which is incorporated herein by reference.

The apertures formed in the elastic films desirably may have an open area in the range of about 5% to about 50%, more desirably in the range of about 10% to about 35%. The apertures formed in the elastic films desirably may have an aperture size in the range of about 100 to about 3000 microns equivalent circular diameter (ECD), more desirably in the range of about 100 to about 700 microns. Because the films are elastic, the size of the aperture openings may increase upon stretching of the elastic film, thus increasing the breathability and exposing the underlying layer. In one embodiment, the apertures in the elastic films desirably have a density of about 1 to about 100 apertures per square centimeter. The apertured elastic film may have one or more zones or areas which are apertured and one or more zones or areas that are not apertured. Such an arrangement creates first areas or zones of higher strength and lower breathability and second areas or zones of lower strength and higher breathability. The aperture openings may have any suitable shape, for example, circular, triangular, square, rectangular, slits, and so forth.

Bonding between the apertured, elastic film and the breathable, extensible film may be achieved either through use of an internal tackifier in one of the films or through the use of a separate adhesive or as a combination of internal tackifier and separate adhesive bonding. In some embodiments, an adhesive, such as a melt-spray type adhesive, is employed. In certain embodiments, the adhesive is sprayed directly onto either the elastic film or the breathable, extensible film. However, other arrangements of adhesive application, such as brushing or the like, may also be utilized. The present invention is not limited to any particular bonding mechanism.

Particular meltspray adhesives that may be utilized include meltspray adhesives available from Bostik Inc. of Huntingdon Valley, Penn. and Super 77 Multipurpose Spray Adhesive available from 3M of Minneapolis, Minn. These adhesives may be applied through a hot melt spray die at an elevated temperature of approximately 300-375° F. to the inner surface of the facing. The meltspray adhesive usually will form a very lightweight layer of about 0.1 to about 3 grams per square meter (“gsm”) of adhesive in the final composite. Desirably, the adhesives are elastic as well.

Nip rolls may be used to apply pressure to the adhesive-coated films to result in the necessary lamination. The films are bonded together at a fairly high surface pressure, which may be between about 2 and 300 pounds per linear inch (“pli”). A typical bonding pressure may be between about 10 pli and about 100 pli.

In one embodiment, the coefficient of friction of the surface of the extensible, breathable barrier film may be higher than or lower than the coefficient of friction of the exposed surface of the apertured elastic film. In a further embodiment, the elastic film may be slit apertured, thereby resulting in the extensible, breathable barrier film being substantially completely obscured until that time when the laminate is stretched. When the laminate is stretched, the apertures grow in size, exposing the underlying film to increase the breathability and change the overall coefficient of friction. As one example, a lower coefficient of friction in the underlying extensible, breathable barrier film may be advantageous in an application where a garment, such as, for example, a training pant, needs to slide on easily while in a stretched position, but after retraction a higher coefficient of friction would aid the garment in staying in position. Desirably, the surface of the extensible, breathable, nonelastic film exposed by the apertures in the elastic film has a coefficient of friction at least 25% less than the coefficient of friction of the exposed surface of the elastic film. Alternatively, the exposed apertured film may have a low coefficient of friction to enable donning the garment while the elastic, breathable barrier film laminate is in relaxed position, then the laminate is stretched to a final position to secure the garment, thereby exposing the underlying higher coefficient of friction to aid the garment staying in position. Thus the garment is held on by the elastic retraction tension and the increased coefficient of friction from the exposed extensible, breathable barrier film. Desirably, the surface of the extensible, breathable, nonelastic film exposed by the apertures in the elastic film would have a coefficient of friction at least 25% less than the coefficient of friction of the exposed surface of the elastic film.

In one embodiment, the present invention is directed to elastic, breathable barrier laminate structures including at least one layer of the film laminate 12 herein disclosed. In general, the individual layers of the elastic, breathable barrier laminate structures of the present invention may be adhesively bonded one to another. For example, the layers of the elastic, breathable barrier laminate structures may be adhesively bonded by use of a spray adhesive with sufficient bonding strength to form an elastic, breathable barrier laminate structure which may be stretched and relaxed to provide the desired degree of elasticity. The elastic, breathable barrier laminate structures of the present invention may be, for example, stretch-bonded laminate materials, neck-bonded laminate materials, and so forth.

The web or webs to which one or more of the film laminates 12 are bonded may themselves be elastic or may comprise one or more non-elastic webs. Generally, in applications where the feel of the composite material is of importance, a non-elastic web such as a bonded carded nonelastic polyester or nonelastic polypropylene fiber web, a spunbonded nonelastic polyester or polypropylene nonelastic fiber web, nonelastic cellulosic fiber webs, e.g., cotton fiber webs, polyamide fiber webs, e.g., nylon 6-6 webs, and blends of two or more of the foregoing may be utilized. Generally, woven, nonwoven, or knitted materials of any textile or other material suitable for the purpose may be used. However, relatively inexpensive and attractive composite fabrics with good hand and feel and with good stretchability and recovery characteristics have been attained by bonding to one or both sides of an elastic web (such as a fibrous elastic web) a bonded carded polyester web, a spunbonded polypropylene fiber web, necked nonwoven webs, and single and multi-layer combinations thereof. In one embodiment, the composite elastic laminate structures of the present invention may be either neck-bonded or stretch-bonded laminate materials.

The layers of the composite laminate structures of the present invention may be adhesively bonded together without the addition of heat. The use of adhesive bonding may be desired in the laminate structure in order to prevent stretching, thinning, or other damage to the individual layers. Such damage may lead to areas of weakness in the laminate and possible breaks or ruptures forming in the laminate materials under expected use conditions.

Any suitable adhesives which do not require elevated temperatures in order to form a bond may be utilized in the present invention. For example, in one embodiment, spray adhesives such as 2525A or 2096, both available from Bostik Inc. of Huntingdon Valley, Pa. may be used.

Latex materials may also serve as the adhesive joining two layers in the laminate structure of the present invention. Examples of latex adhesives include latex 8085 from Bostik Inc. The latex may be any latex, synthetic latex (e.g., a cationic or anionic latex), or natural latex or derivatives thereof.

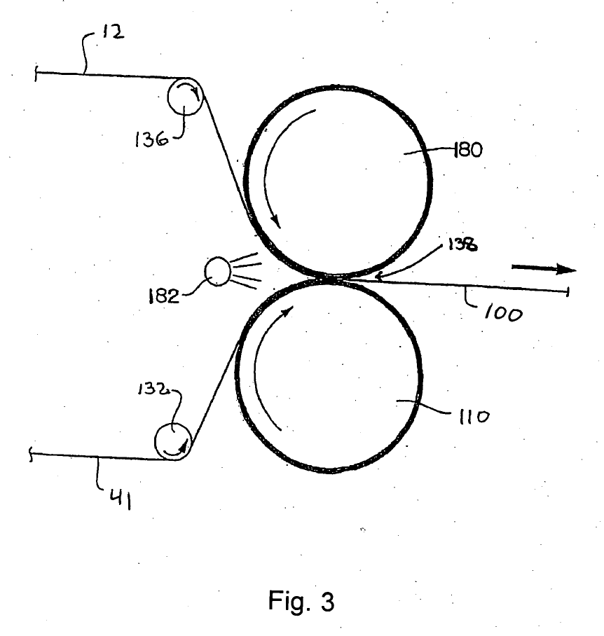

The layers of the laminate composite material may be adhesively bonded in any suitable fashion. For example, one possible embodiment for a method of adhesively bonding a film laminate 12 with another layer to form an elastic composite laminate is illustrated in FIG. 3. As can be seen in the figure, the film laminate 12 and a facing web 41 may be brought together after formation by use of guide rolls 132 and 136, and an adhesive 182 may be applied to one or both layers prior to or at contact between the layers which may bond the layers of the laminate material together. For example, the film laminate 12 and a facing web 41 may be brought together in a nip 138, between first and second laminating rolls 110 and 180 to form an elastic, breathable barrier laminate structure 100. In this embodiment, the layers may be attached through utilization of the adhesive alone, or optionally, pressure may also be applied in the nip 138 as the layers are brought together, to further enhance the bond between the layers. As another option, the first and second rolls 110 and 180 may be heated to cause a thermal bond between the film laminate 12 and the facing web 41 and/or point bonding may be used. The temperature at which the laminating rollers are heated depends on the properties of the film laminate 12 and the facing web 41 but is usually in the range of 200-275° F. (93-135° C.). The adhesive may be applied to one or both of the layers of the laminate material by any method. For example, in addition to a spray method, as illustrated in FIG. 3, an adhesive may be applied through any known printing, coating, or other suitable transfer method. In one embodiment, the basis weight of the adhesive may be about 1 gsm or greater, such as from about 2 gsm to about 50 gsm, more specifically about 2 gsm to about 10 gsm. Alternatively, the basis weight of the added adhesive may be less than about 5 gsm.

The laminate structures of the present invention may include 2, 3, 4 or even more individual layers. For example, the laminate structure may include the elastic breathable film laminate 12 sandwiched between two other non-elastic facing layers. In another embodiment, the elastic breathable film laminate 12 may serve as an outer layer of a laminate structure and one or more additional layers (which may include additional elastic webs) bonded to one side of the elastic film. Any other combination of webs in a laminate structure is encompassed by the present invention.

The process shown in FIG. 3 also may be used to create a multi-layer web/film laminate. The only modification to the previously described process is to feed a supply of a second facing layer (not shown) into the first and second laminating rolls 110 and 180 on a side of the film laminate 12 opposite that of the first facing web 41. One or both of the facing layers may be formed directly in line, or may be unwound from a supply roll. In either event, the second facing material is fed into the first and second laminating rolls 110 and 180 as it is laminated to the film laminate 12 in the same fashion as the first facing web 41. Such multi-layer laminates are particularly useful in medical and industrial protective garment/outer workwear applications.

The laminate structures of the present invention may be utilized generally in any article calling for elastic, breathable barrier materials. For example, the laminate structure may be converted and included in many different products, such as various personal care products. Products which may utilize the novel laminate structures may include, for example, bandage materials for both human and animal bandaging products, extensible protective covers, wraps, workwear, and outerwear for medical and industrial applications, surgical drapes and gowns, coveralls, lab coats undergarments, feminine hygiene pads, incontinence control pads, and disposable garments including incontinence garments, disposable diapers, training pants, and the like.

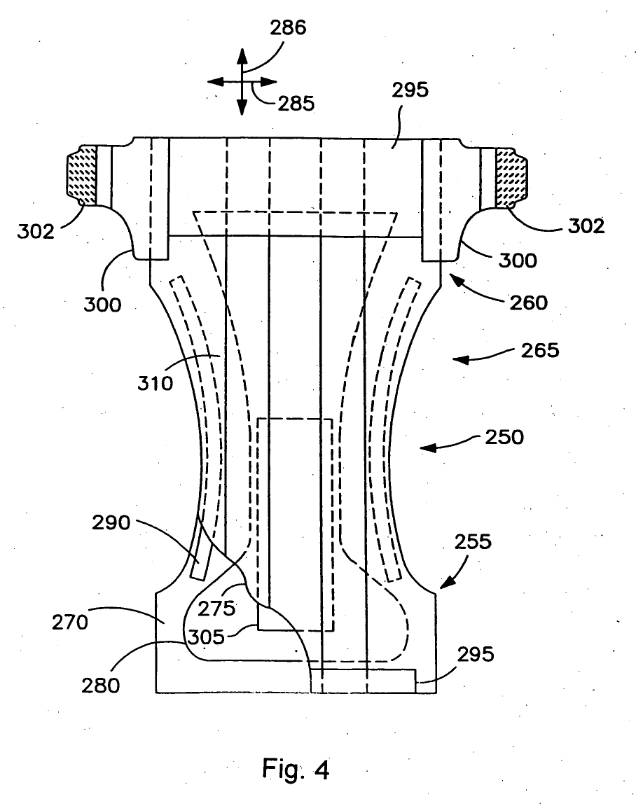

Such film laminate materials may be useful in providing elastic waist, leg cuff/gasketing, stretchable ear, side panel or stretchable outer cover applications. While not intending to be limiting, FIG. 4 is presented to illustrate the various components of a personal care product, such as a diaper, that may take advantage of such elastic film laminate materials. Other examples of personal care products that may incorporate such materials are training pants (such as in side panel materials) and feminine care products. By way of illustration only, training pants suitable for use with the present invention and various materials and methods for constructing the training pants are disclosed in U.S. Pat. No. 6,761,711 to Fletcher et al; U.S. Pat. No. 4,940,464 to Van Gompel et al.; U.S. Pat. No. 5,766,389 to Brandon et al.; and U.S. Pat. No. 6,645,190 Olson et al., which are each incorporated herein by reference in its entirety.

With reference to FIG. 4, a disposable diaper 250 generally defines a front waist section 255, a rear waist section 260, and an intermediate section 265 which interconnects the front and rear waist sections. The front and rear waist sections 255 and 260 include the general portions of the diaper which are constructed to extend substantially over the wearer's front and rear abdominal regions, respectively, during use. The intermediate section 265 of the diaper includes the general portion of the diaper that is constructed to extend through the wearer's crotch region between the legs. Thus, the intermediate section 265 is an area where repeated liquid surges typically occur in the diaper.

The diaper 250 includes, without limitation, an outer cover, or backsheet 270, a liquid permeable bodyside liner, or topsheet, 275 positioned in facing relation with the backsheet 270, and an absorbent core body, or liquid retention structure, 280, such as an absorbent pad, which is located between the backsheet 270 and the topsheet 275. The backsheet 270 defines a length, or longitudinal direction 286, and a width, or lateral direction 285 which, in the illustrated embodiment, coincide with the length and width of the diaper 250. The liquid retention structure 280 generally has a length and width that are less than the length and width of the backsheet 270, respectively. Thus, marginal portions of the diaper 250, such as marginal sections of the backsheet 270 may extend past the terminal edges of the liquid retention structure 280. In the illustrated embodiments, for example, the backsheet 270 extends outwardly beyond the terminal marginal edges of the liquid retention structure 280 to form side margins and end margins of the diaper 250. The topsheet 275 is generally coextensive with the backsheet 270 but may optionally cover an area which is larger or smaller than the area of the backsheet 270, as desired.

To provide improved fit and to help reduce leakage of body exudates from the diaper 250, the diaper side margins and end margins may be elasticized with suitable elastic members, as further explained below. For example, as representatively illustrated in FIG. 4, the diaper 250 may include leg elastics 290 which are constructed to operably tension the side margins of the diaper 250 to provide elasticized leg bands which can closely fit around the legs of the wearer to reduce leakage and provide improved comfort and appearance. Waist elastics 295 are employed to elasticize the end margins of the diaper 250 to provide elasticized waistbands. The waist elastics 295 are configured to provide a resilient, comfortably close fit around the waist of the wearer.

The elastic breathable barrier laminate materials of the inventive structure are suitable for use as the leg elastics 290 and waist elastics 295. Exemples of such materials are laminate sheets which either comprise or are adhered to the backsheet, such that elastic constrictive forces are imparted to the backsheet 270.

As is known, fastening means, such as hook and loop fasteners, may be employed to secure the diaper 250 on a wearer. Alternatively, other fastening means, such as buttons, pins, snaps, adhesive tape fasteners, cohesives, fabric-and-loop fasteners, or the like, may be employed. In the illustrated embodiment, the diaper 250 includes a pair of side panels 300 (or ears) to which the fasteners 302, indicated as the hook portion of a hook and loop fastener, are attached. Generally, the side panels 300 are attached to the side edges of the diaper in one of the waist sections 255, 260 and extend laterally outward therefrom. The side panels 300 may be elasticized or otherwise rendered elastomeric by use of an elastic breathable barrier laminate materials made from the inventive structure. Examples of absorbent articles that include elasticized side panels and selectively configured fastener tabs are described in PCT Patent Application WO 95/16425 to Roessler; U.S. Pat. No. 5,399,219 to Roessler et al.; U.S. Pat. No. 5,540,796 to Fries; and U.S. Pat. No. 5,595,618 to Fries; each of which is hereby incorporated by reference in its entirety.

The diaper 250 may also include a surge management layer 305, located between the topsheet 275 and the liquid retention structure 280, to rapidly accept fluid exudates and distribute the fluid exudates to the liquid retention structure 280 within the diaper 250. The diaper 250 may further include a ventilation layer (not illustrated), also called a spacer, or spacer layer, located between the liquid retention structure 280 and the backsheet 270 to insulate the backsheet 270 from the liquid retention structure 280 to reduce the dampness of the garment at the exterior surface of a breathable outer cover, or backsheet, 270. Examples of suitable surge management layers 305 are described in U.S. Pat. No. 5,486,166 to Bishop and U.S. Pat. No. 5,490,846 to Ellis.

As representatively illustrated in FIG. 4, the disposable diaper 250 may also include a pair of containment flaps 310 which are configured to provide a barrier to the lateral flow of body exudates. The containment flaps 310 may be located along the laterally opposed side edges of the diaper adjacent the side edges of the liquid retention structure 280. Each containment flap 310 typically defines an unattached edge which is configured to maintain an upright, perpendicular configuration in at least the intermediate section 265 of the diaper 250 to form a seal against the wearer's body. The containment flaps 310 may extend longitudinally along the entire length of the liquid retention structure 280 or may only extend partially along the length of the liquid retention structure. When the containment flaps 310 are shorter in length than the liquid retention structure 280, the containment flaps 310 can be selectively positioned anywhere along the side edges of the diaper 250 in the intermediate section 265. Such containment flaps 310 are generally well known to those skilled in the art. The containment flaps 310 may be elasticized or otherwise rendered elastomeric by use of an elastic breathable barrier laminate materials made from the inventive structure. For example, suitable constructions and arrangements for containment flaps 310 are described in U.S. Pat. No. 4,704,116 to K. Enloe.

The diaper 250 may be of various suitable shapes. For example, the diaper may have an overall rectangular shape, T-shape or an approximately hour-glass shape. In the shown embodiment, the diaper 250 has a generally I-shape. Other suitable components which may be incorporated on absorbent articles of the present invention may include waist flaps and the like which are generally known to those skilled in the art. Examples of diaper configurations suitable for use in connection with the elastic breathable barrier laminate materials of the instant invention which may include other components suitable for use on diapers are described in U.S. Pat. No. 4,798,603 to Meyer et al.; U.S. Pat. No. 5,176,668 to Bernardin; U.S. Pat. No. 5,176,672 to Bruemmer et al.; U.S. Pat. No. 5,192,606 to Proxmire et al.; and U.S. Pat. No. 5,509,915 to Hanson et al.; each of which is hereby incorporated by reference in its entirety.

The various components of the diaper 250 are assembled together employing various types of suitable attachment means, such as adhesive bonding, ultrasonic bonding, thermal point bonding or combinations thereof. In the shown embodiment, for example, the topsheet 275 and backsheet 270 may be assembled to each other and to the liquid retention structure 280 with lines of adhesive, such as a hot melt, pressure-sensitive adhesive. Similarly, other diaper components, such as the elastic members 290 and 295, fastening members 302, and surge layer 305 may be assembled into the article by employing the above-identified attachment mechanisms.

The present invention may be better understood by reference to the Example below. However, it is to be understood that the invention is not limited thereto.

### EXAMPLE

A breathable, extensible film having a core layer (86 weight percent) and first and second skin layers (2% and 12 weight percent, respectively) was formed using a conventional blown film process. The core layer included 26.4 weight percent styrene-ethylenebutylene-styrene block copolymer, 6.6 weight percent 10 melt index metallocene catalyzed polyethylene, and 67 weight percent calcium carbonate concentrate. The calcium carbonate concentrate included 75% calcium carbonate dispersed into a polymeric carrier resin. The calcium carbonate, available from Omya, Inc. North America of Proctor, Vt., and designated as 2SST, has an average particle size of 2 microns with a top cut of 8-10 microns and a coating of approximately 1% stearic acid. The polymeric carrier resin, present in the concentrate at 25 weight percent, was a DOWLEX™ 2517 LLDPE resin supplied by The Dow Chemical Company of Midland Mich. DOWLEX 2517™ resin has a density of 0.917 g/cc and a melt index of 25. The first skin layer on the first side of the core layer included 100 weight percent low density polyethylene available as LD202.48 from ExxonMobil Chemical Company. The second skin layer on the second side of the core layer 67 weight percent calcium carbonate concentrate as described above and 33 weight percent 10 melt index metallocene catalyzed polyethylene. The breathable, extensible film was stretched about 3.2 times its original length using a machine direction orienter resulting in a stretched basis weight of approximately 30 grams per square meter (gsm).

A 44 gsm apertured elastic film having a core layer (88.5 weight percent) and first and second identical skin layers (5.75 weight percent each) was formed using a conventional blown film process. The core layer included 75 weight percent styrene-isoprene-styrene block copolymer having 18% polystyrene content available as VECTOR 4111A from Dexco Polymers of Houston, Tex., 20 weight percent styrene-butadiene-styrene block copolymer having 29% polystyrene content available as VECTOR 8508 from Dexco Polymers, 0.05 weight percent organosilicone available as SILQUEST PA-1 from GE Silicones of Wilton, Conn., and 4.95 weight percent polyethylene carrier resin. The skin layers included 100 weight percent low density polyethylene available as MARFLEX 1019 from Chevron Phillips Chemical Company, LLC. The elastic film was apertured using a vacuum aperturing apparatus. The circular aperture openings in the elastic film were about 250 microns in diameter and provided about 11% open area in the elastic film. After aperturing, the basis weight of the elastic film was measured as 35 gsm. Some samples of the apertured elastic film were then crosslinked using a 20 megarad electron beam treatment at 200 kV.

Film laminates of the extensible, breathable film and both the uncrosslinked and crosslinked elastic film were prepared by cutting similarly sized samples from the films and laminating the films together using about 1 gsm spray adhesive available as Super 77 Multipurpose Spray Adhesive from 3M of Minneapolis, Minn.

The breathability of the film laminates was measured using a Mocon-type test method as described above. The uncrosslinked laminate was found to have a breathability of about 820 g/m²/24 hours and the crosslinked laminate was found to have a breathability of about 760 g/m²/24 hours.

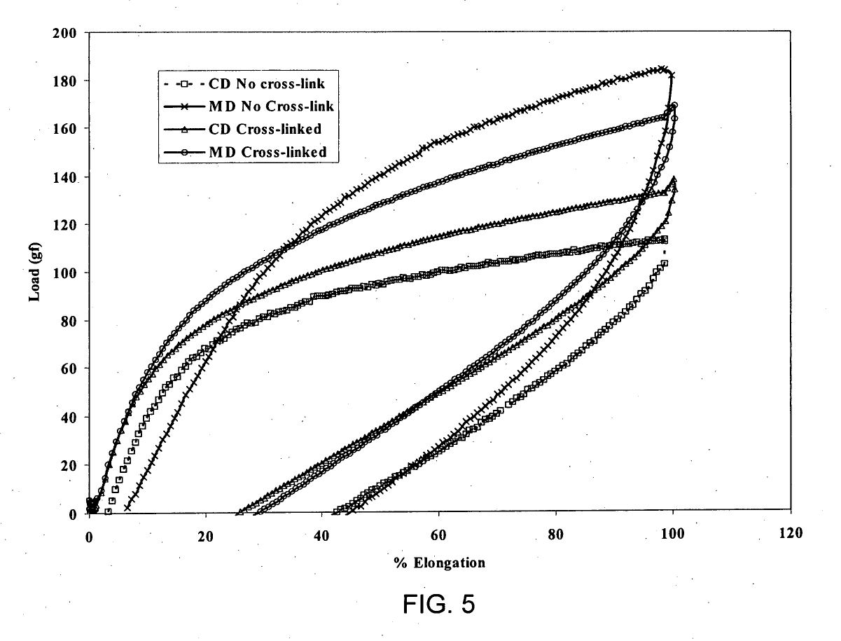

Load-elongation mechanical tests of the laminated films including the uncrosslinked and crosslinked elastic apertured film layers were performed using a Sintech 1/s frame. Both MD and CD film samples were prepared using a rectangular 3 inch wide die. The samples were clamped into the jaws of the testing frame, set at a 3″ grip-to-grip distance. The displacement of the crosshead was set at a speed of 20 inches/min. The film samples were stretched to about 100% at room temperature (about 20° C.) and then allowed to retract. The load and elongation were recorded and are depicted in FIG. 5. The elastic nature of the samples is evident from FIG. 5, where it is shown that the uncross linked samples were extensible to at least about 100% longer than the initial length and retracted to about 42% longer than the initial length. The crosslinked samples were extensible to at least about 100% longer than the initial sample length and retracted to about 25% longer than the initial length.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto. Further, it is recognized that many embodiments may be conceived that do not achieve all of the advantages of some embodiments, yet the absence of a particular advantage shall not be construed to necessarily mean that such an embodiment is outside the scope of the present invention. In addition, it should be noted that any given range presented herein is intended to include any and all lesser included ranges. For example, a range of from 45-90 would also include 50-90; 45-80; 46-89 and the like. Thus, the range of 95% to 99.999% also includes, for example, the ranges of 96% to 99.1%, 96.3% to 99.7%, and 99.91% to 99.999%, etc.

What is claimed is:

1. An elastic, breathable barrier sheet material comprising:
a first layer comprising an apertured elastic film; and
a second layer comprising an extensible, breathable, non-elastic film;
wherein the first layer is bonded to the second layer.

2. The elastic, breathable barrier sheet material of claim 1, wherein the second layer is unapertured.

3. The elastic, breathable barrier sheet material of claim 1, further comprising an adhesive between the first and second layer.

4. The elastic, breathable barrier sheet material of claim 3, wherein the adhesive between the first and second layer includes a hot melt adhesive.

5. The elastic, breathable barrier sheet material of claim 1, wherein the apertured elastic film comprises a styrenic block copolymer.

6. The elastic, breathable barrier sheet material of claim 5, where in the apertured elastic film further comprises a plastomer wax.

7. The elastic, breathable barrier sheet material of claim 5, wherein the styrenic block copolymer is crosslinked.

8. The elastic, breathable barrier sheet material of claim 1, wherein the extensible, breathable film comprises 50 to 70 percent by volume filler particles.

9. The elastic, breathable barrier sheet material of claim 1, wherein the apertured elastic film comprises apertured zones and unapertured zones.

10. The elastic, breathable barrier sheet material of claim 1, wherein the apertured elastic film comprises a plurality of slit openings.

11. The elastic, breathable barrier sheet material of claim 1, wherein the surface of the extensible, breathable, nonelastic film exposed by the apertures in the elastic film has a coefficient of friction different than the coefficient of friction of the exposed surface of the elastic film.

12. The elastic, breathable barrier sheet material of claim 11, wherein the surface of the extensible, breathable, nonelastic film exposed by the apertures in the elastic film has a coefficient of friction at least 25% greater than the coefficient of friction of the exposed surface of the elastic film.

13. The elastic, breathable barrier sheet material of claim 11, wherein the surface of the extensible, breathable, nonelastic film exposed by the apertures in the elastic film has a coefficient of friction at least 25% less than the coefficient of friction of the exposed surface of the elastic film.

14. An elastic, breathable barrier laminate structure comprising:
a first sheet material comprising:
a first layer comprising an apertured elastic film; and
a second layer comprising an extensible, breathable, non-elastic film;
wherein the first layer is bonded to the second layer; and
a second sheet material bonded to the first sheet material.

15. The elastic, breathable barrier laminate structure of claim 14, wherein the second layer is unapertured.

16. The elastic, breathable barrier laminate structure of claim 14, further comprising an adhesive between the first and second layer.

17. The elastic, breathable barrier laminate structure of claim 14, wherein the apertured elastic film comprises a styrenic block copolymer.

18. The elastic, breathable barrier laminate structure of claim 17, wherein the styrenic block copolymer is crosslinked.

19. The elastic, breathable barrier laminate structure of claim 14, wherein the extensible, breathable, non-elastic film comprises 50 to 70 percent by volume filler particles.

20. The elastic, breathable barrier laminate structure of claim 14, wherein the second sheet material is a spunbonded facing material.

21. The elastic, breathable barrier laminate structure of claim 14, wherein the second sheet material is a necked sheet material.

22. The elastic, breathable barrier laminate structure of claim 14, wherein the breathable, elastic laminate structure is a stretch bonded laminate.

23. The elastic, breathable barrier laminate structure of claim 14, wherein the apertured elastic film comprises apertured zones and unapertured zones.

24. The elastic, breathable barrier laminate structure of claim 14, wherein the apertured elastic film comprises a plurality of slit openings.

25. The elastic, breathable barrier laminate structure of claim 14, wherein the surface of the extensible, breathable, nonelastic film exposed by the apertures in the elastic film has a coefficient of friction different than the coefficient of friction of the exposed surface of the elastic film.

26. The elastic, breathable barrier laminate structure of claim 25, wherein the surface of the extensible, breathable, nonelastic film exposed by the apertures in the elastic film has a coefficient of friction at least 25% greater than the coefficient of friction of the exposed surface of the elastic film.

27. The elastic, breathable barrier laminate structure of claim 25, wherein the surface of the extensible, breathable, nonelastic film exposed by the apertures in the elastic film has a coefficient of friction at least 25% less than the coefficient of friction of the exposed surface of the elastic film.

28. A personal care product comprising:
an elastic, breathable barrier laminate structure wherein the elastic laminate structure comprises:
a first sheet material comprising:
a first layer comprising an apertured elastic film; and
a second layer comprising an extensible, breathable, non-elastic film;
wherein the first layer is bonded to the second layer; and,
a second sheet material bonded to the first sheet material.

29. The personal care product of claim 28, wherein the second layer is unapertured.

30. The personal care product of claim 28, further comprising an adhesive between the first and second layer.

31. The personal care product of claim 28, wherein the apertured elastic film comprises a styrenic block copolymer.

32. The personal care product of claim 31, wherein the styrenic block copolymer is crosslinked.

33. The personal care product of claim 28, wherein the extensible, breathable, non-elastic film comprises 50 to 70 percent by volume filler particles.

34. The personal care product of claim 28, wherein the second sheet material is a spunbonded facing material.

35. The personal care product of claim 28, wherein the second sheet material is a necked sheet material.

36. The personal care product of claim 28, wherein the elastic laminate structure is a stretch bonded laminate.

37. The personal care product of claim 28, wherein the apertured elastic film comprises apertured zones and unapertured zones.

38. The personal care product of claim 28, wherein the apertured elastic film comprises a plurality of slit openings.

39. The personal care product of claim 28, wherein the surface of the extensible, breathable, nonelastic film exposed by the apertures in the elastic film has a coefficient of friction different than the coefficient of friction of the exposed surface of the elastic film.

40. The personal care product of claim 39, wherein the surface of the extensible, breathable, nonelastic film exposed by the apertures in the elastic film has a coefficient of friction at least 25% greater than the coefficient of friction of the exposed surface of the elastic film.

41. The personal care product of claim 39, wherein the surface of the extensible, breathable, nonelastic film exposed by the apertures in the elastic film has a coefficient of friction at least 25% less than the coefficient of friction of the exposed surface of the elastic film.

42. A process for making an elastic, breathable barrier laminate structure, the process comprising the steps of:
forming an elastic film;
aperturing the elastic film;
forming an extensible, breathable, non-elastic film; and
bonding the apertured elastic film to the extensible, breathable, non-elastic film to form a film laminate.

43. The process for making an elastic, breathable barrier laminate structure of claim 42, wherein the extensible, breathable, non-elastic film is unapertured.

44. The process for making an elastic, breathable barrier laminate structure of claim 42, wherein the apertured elastic film is bonded to the extensible, breathable, non-elastic film with an adhesive.

45. The process for making an elastic, breathable barrier laminate structure of claim 42, wherein the apertured elastic film comprises a styrenic block copolymer.

46. The process for making an elastic, breathable barrier laminate structure of claim 45, wherein the styrenic block copolymer is crosslinked.

47. The process for making an elastic, breathable barrier laminate structure of claim 42, wherein the extensible, breathable, non-elastic film comprises 50 to 70 percent by volume filler particles.

48. The process for making an elastic, breathable barrier laminate structure of claim 42, further comprising the step of bonding a breathable facing sheet material to the film laminate.

49. The process for making an elastic, breathable barrier laminate structure of claim 48, wherein the breathable facing sheet material is a spunbond material.

50. The process for making an elastic, breathable barrier laminate structure of claim 48, wherein the breathable facing sheet material is a necked sheet material.

51. The process for making an elastic, breathable barrier laminate structure of claim 48, further comprising the steps of stretching the film laminate prior to the step of bonding a breathable facing sheet material to the film laminate to form a stretch bonded laminate.

52. The process for making an elastic, breathable barrier laminate structure of claim 42, further comprising the step of stretching the apertured elastic film prior to bonding the apertured elastic film to the extensible, breathable non-elastic film to form a stretch-bonded film laminate.

53. The process for making an elastic, breathable barrier laminate structure of claim 42, wherein the apertured elastic film comprises apertured zones and unapertured zones.

54. The process for making an elastic, breathable barrier laminate structure of claim 42, wherein the apertured elastic film comprises a plurality of slit openings.

55. The process for making an elastic, breathable barrier laminate structure of claim 42, wherein the surface of the extensible, breathable, nonelastic film exposed by the apertures in the elastic film has a coefficient of friction different than the coefficient of friction of the exposed surface of the elastic film.

56. The process for making an elastic, breathable barrier laminate structure of claim 55, wherein the surface of the extensible, breathable, nonelastic film exposed by the apertures in the elastic film has a coefficient of friction at least 25% greater than the coefficient of friction of the exposed surface of the elastic film.

57. The process for making an elastic, breathable barrier laminate structure of claim 55, wherein the surface of the extensible, breathable, nonelastic film exposed by the apertures in the elastic film has a coefficient of friction at least 25% less than the coefficient of friction of the exposed surface of the elastic film.
